(19) United States
(12) Patent Application Publication
(10) Pub. No.: US 2008/0275780 A1
(43) Pub. Date: Nov. 6, 2008

(54) Sales Aid For Hot Tubs and Method of Selling

(76) Inventor: Michael L. Hodak, Venetia, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/037,339

(22) Filed: Feb. 26, 2008

Related U.S. Application Data
(60) Provisional application No. 60/903,459, filed on Feb. 26, 2007.

(51) Int. Cl. G06Q 30/00

(52) U.S. Cl. 705/14

(57) ABSTRACT

A sales aid for selling hot tubs comprising a full-size pattern of a selected hot tub model which is imaged on a flexible, lightweight carrier sheet or fabric such as a vinyl poly blend which is durable and easily transportable. The full-size pattern is preferably a color photographic image of the actual hot tub model being offered for sale. A hot tub dealer or exhibitor may have one or more patterns of the invention for each of the desired hot tub models it wishes to market, without the need to have the actual hot tubs occupying valuable floor space in the store. When a prospective purchaser wants to ensure a proper site fit of the hot tub on his or her premises, the pattern is loaned to the prospective purchaser with the understanding that it will be returned to the store. This arrangement causes the prospective purchaser to return to the store, at which time the sale is hopefully made, in accordance with the sales aid method of the invention.

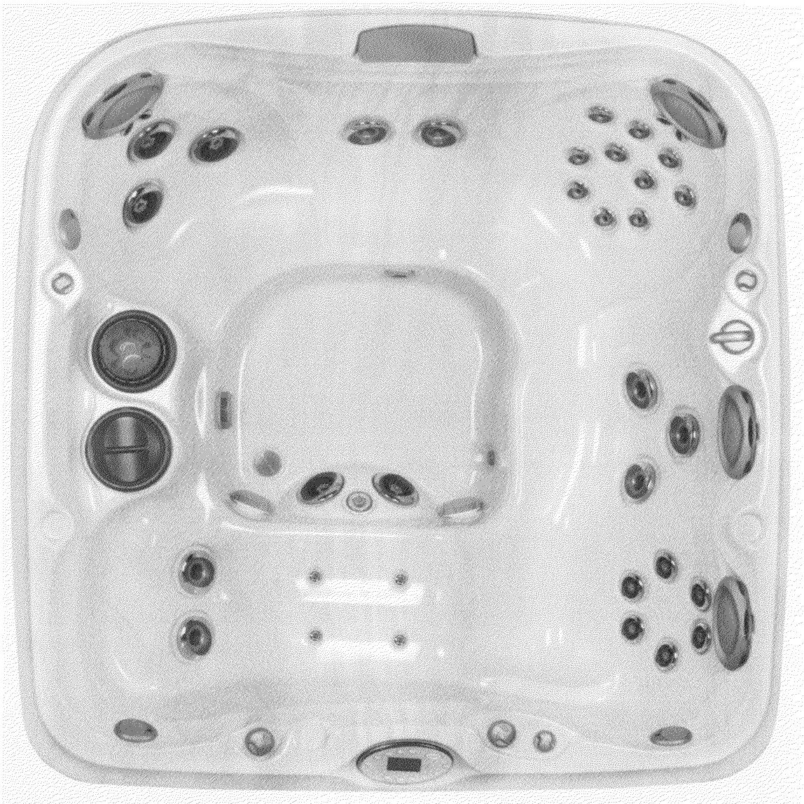

### BACKGROUND OF THE INVENTION

1. Field of the Invention

The present invention relates generally to sales aids for marketing and selling hot tubs, spas and the like for use by distributors and prospective purchasers. The invention further pertains to a method of selling this same line of products.

2. Description of Related Art

Retail distributors of hot tubs, as well as exhibitors of hot tubs and spas at home and garden shows, for example, require a good deal of floor space to show their product lines to prospective purchasers due to the considerable size of the hot tub/spa products (hereinafter referred to collectively as hot tubs). The floor space in a showroom or exhibit area directly equates into additional expense for the dealer/retailer and consequently raises the cost of the hot tub to the customer. These products are generally quite large and bulky and require transportation, labor and effort to move and position on the showroom floor and/or exhibit floor.

It is also known that prospective customers who may be close to making a purchase of a hot tub at the retail store usually hesitate prior to committing to the purchase because they want to go home first and measure their deck or other site where the hot tub is to be placed in order to make sure that it fits.

The present invention is intended to be used by retail distributors and exhibitors of hot tubs as a sales tool and also as a floor space savings means so as to decrease the amount of showroom and exhibit floor space required to show and sell a complete line of full-size hot tubs. The present invention also reduces the handling and shipping expenses incurred in showing hot tubs in stores and exhibits, and also reduces the problem of returning and replacing hot tubs from a job site due to improper sizing. The present invention is also used as a means to satisfy customers with respect to their hot tub size and proper site fitting issues while also causing the prospective customer to return to the retail store and hopefully commit to the purchase.

### SUMMARY OF THE INVENTION

Briefly stated, the present invention is directed to a sales aid for selling hot tubs comprising a full-size pattern of a selected hot tub model which is imaged on a flexible, lightweight carrier sheet or fabric such as a vinyl poly blend which is durable and easily transportable. The full-size pattern is preferably a color photographic image of the actual hot tub model being offered for sale. A hot tub dealer or exhibitor may have one or more patterns of the invention for each of the desired hot tub models it wishes to market, without the need to have the actual hot tubs occupying valuable floor space in the store. When a prospective purchaser wants to ensure a proper site fit of the hot tub on his or her premises, the pattern is loaned to the prospective purchaser with the understanding that it will be returned to the store. This arrangement causes the prospective purchaser to return to the store, at which time the sale is hopefully made, in accordance with the sales aid method of the invention.

### BRIEF DESCRIPTION OF THE DRAWING

The drawing figure is a photographic pattern, in plan view, of a hot tub according to the present invention.

### DETAILED DESCRIPTION OF THE INVENTION

A pattern according to the present invention, as shown in the appended drawing, is a full-size image of a selected hot tub model imprinted on a flexible image carrier means. The image of the hot tub on the pattern is preferably done in color to provide a true representation of the actual product.

The pattern is preferably made by taking an overhead (plan view) digital photo of a selected hot tub model. The digital image is then expanded and transferred in a known manner to an image carrier means such as a sheet of vinyl flex poly blend. The full-size image of the selected hot tub may be set on the vinyl flex poly blend sheet by ink jet digital printing, which in itself is known in the art of large sign or billboard making.

In use, the hot tub pattern may be used by retail distributors with limited showroom space to exhibit the actual size and appearance of selected hot tub models. The same is true with exhibitors at hot tub shows who can thus exhibit a full line of hot tubs within a limited exhibit booth size.

As a sales aid and method of selling hot tubs according to the invention, the pattern of a selected hot tub is loaned to a prospective purchaser to take home under the condition that the pattern be returned to the store. Once in the possession of the prospective purchaser, the proper sized site for the hot tub is confirmed with the use of the pattern. In addition, with an actual image of the hot tub on the premises, the prospective purchaser will likely be persuaded to make the purchase. When the prospective purchaser returns the pattern to the store, the likelihood of purchase is greatly increased.

A number of benefits to the dealer/retailer of the invention are more fully enumerated below.

### Benefits to the Dealer:

1. Establishes contact with the customer and qualifies the level of interest with the customer. Personal information is exchanged and financial commitment has begun when a customer leaves a deposit for the pattern.

2. Eliminates a customer's ability to leave without some commitment while using the excuse “I'll have to go home and measure”.

3. Creates a need for the customer to return to the store with the pattern, allowing a salesperson a second chance to close the sale.

4. Perpetuates excitement. The product is now in living color and the customer can visualize it on their deck. Once the customer has the pattern at his home, the family members become involved and begin to live the dream.

5. Imparts a higher level of professionalism by offering a professional sales tool not offered by other dealers and manufacturers.

6. Helpful for a delivery crew, as it eliminates pre-delivery site inspection to determine if the hot tub will fit in the space provided and also to position the hot tub components, such as steps, lounge, waterfall, and control panel correctly. Some tubs can weigh over 1000 pounds, making them cumbersome and expensive to move twice.

7. A small dealer is able to display all ten models, for example, instead of just a few, in a showroom where size was previously inadequate. The full size images may be displayed on a vertically hung rack, much like in a known carpet display rack, to conserve showroom floor space. When a particular model hot tub pattern is of interest, the vertically hung image may be removed from the rack and laid out on the floor for viewing. Of course, the full size image carrying patterns could also be folded into a convenient size for storage/inventory at the store or when a customer wishes to take it home for viewing on site.

8. Beneficial in laying out a retail showroom, home and garden shows, tent sales, and mall shows.

9. Beneficial to a dealer who offers in-home sales. The dealer will be able to show the customer the complete hot tub layout at the time of the sales meeting.

10. If a dealer is out of stock of a particular model, the pattern will enable him to show accurate details and features of the hot tub in living color.

### Benefits to the Customer:

1. The pattern is a dimensionally correct sales aid that is given to a customer to take home and position on their site to determine if the hot tub will appropriately fit in the space the customer has in mind.

2. The customer is better able to position features of the hot tub such as waterfall, control panel, stairs, lounges and benches.

3. The pattern is a life-like photo of the hot tub, allowing customers to visualize it on their deck.

4. Interior colors and cabinet colors will be part of the pattern, eliminating the need for color swatches and cabinet samples.

### Benefits to the Spa Manufacturer:

1. Can be used by professional designers employed by the spa manufacturer to aid a dealer's showroom layout.

2. Displays a level of professionalism by offering a sales tool not offered by other manufacturers that will result in increased market share.

### Additional Embodiments

The invention further contemplates a full size elevation view of the hot tub showing the vertical cabinet surrounding the unit for each particular hot tub model. The elevation image would also be printed on a flexible carrier, like the plan view, and would be paired with the plan view of the hot tub as a sales aid.

The invention claimed is:

1. A sales aid in selling hot tubs comprising a full size image of a hot tub on a carrier means.

2. The sales aid of claim 1 wherein the carrier means is a flexible sheet or fabric.

3. The sales aid of claim 1 wherein the carrier means is a sheet or fabric of a vinyl poly blend.

4. The sales aid of claim 1 wherein the full size image of the hot tub is a color digital image in plan view of the hot tub.

5. The sales aid of claim 4 including at least one full size image in side elevation view of the hot tub.

6. A method of selling hot tubs comprising the steps of:
a. providing a pattern carrying a full size image of the hot tub in plan view;
b. displaying the pattern to a prospective customer; and
c. loaning the pattern to the prospective customer to take to a prospective site for the hot tub.

7. The sales method of claim 6 wherein the loaning step is made with an understanding that the prospective customer is to return the pattern.

8. The sales method of claim 6 wherein the displaying step includes hanging the patterns in a vertical array.
